(19) United States
(12) Patent Application Publication
(10) Pub. No.: US 2016/0006518 A1
(43) Pub. Date: Jan. 7, 2016

(54) OPTICAL INTERCONNECTION DEVICE

(71) Applicant: V TECHNOLOGY., LTD., Yokohama-shi, Kanagawa (JP)

(72) Inventors: Koichi Kajiyama, Kanagawa (JP); Michinobu Mizumura, Kanagawa (JP); Shin Ishikawa, Kanagawa (JP); Masayasu Kanao, Kanagawa (JP); Yoshinori Ogawa, Kanagawa (JP)

(73) Assignee: V TECHNOLOGY CO., LTD., Kanagawa (JP)

(21) Appl. No.: 14/760,378

(22) PCT Filed: Dec. 10, 2013
(86) PCT No.: PCT/JP2013/083033

§ 371 Date: Jul. 10, 2015

(30) Foreign Application Priority Data
Jan. 11, 2013 (JP) 2013-004015
Oct. 11, 2013 (JP) 2013-214230

(51) Int. Cl. H04B 10/80

(52) U.S. Cl. CPC H04B 10/803

(57) ABSTRACT

Signal transmission crosstalk between substrates is suppressed even when light emitting elements or light receiving elements are densely arranged. Provided is an optical interconnection device 1 in which optical signals are sent and received between a plurality of semiconductor substrates arranged in a laminated manner. A light emitting element 2 or a light receiving element 3 arranged in one semiconductor substrate 10 includes a pn junction part 10pn that uses the semiconductor substrate 10 as a common semiconductor layer, and is formed on one surface side of the semiconductor substrate 10. For a pair of the light emitting element 2 and the light receiving element 3 respectively sending and receiving optical signals between the different semiconductor substrates 10, light emitted by the light emitting element 2 is transmitted through the semiconductor substrate 10 and received by the light receiving element 3.

### TECHNICAL FIELD

The present invention relates to an optical interconnection device that enables optical interconnection between substrates.

### BACKGROUND ART

Optical interconnections are now widely prevalent in the field of long-distance signal transmissions using optical fibers due to the characteristics of the optical interconnections such as high-speed and large-capacity transmissions, high noise resistance, and reduced diameters of cables. On the other hand, for a further increase in information processing speed in information processing devices, very-short-distance optical interconnections are indispensable such as optical interconnections between boards, between chips, or in chips, and every effort is being made to develop relevant techniques.

In recent years, a three-dimensional implementation technique has been proposed in which semiconductor substrates are arranged in a laminated manner so as to enable high-density packaging of the semiconductor substrates. Attention has been paid to the optical interconnection between substrates as a technique that implements signal transmissions between the semiconductor substrates arranged in a laminated manner without the need for connections with conductive wires or optical fibers. A related art described in Patent Literature 1 listed below discloses that a plurality of light transmission substrates is arranged in a laminated manner so that a light emitting element provided on one of the substrates and a light receiving element provided on another of the substrates respectively send and receive optical signals.

### RELATED ART LITERATURE

### Patent Literature

### [Patent Literature 1] Japanese Patent Application Laid-open No. 2000-277794

### SUMMARY OF THE INVENTION

When the plurality of substrates is arranged in a laminated manner so that the light emitting element provided on one of the substrates and the light receiving element provided on another of the substrates respectively send and receive optical signals, the positions of the light emitting element and the light receiving element respectively sending and receiving the optical signals need to be accurately aligned with each other on different substrates, and alignment accuracy for the light emitting element or the light receiving element on the substrate is a challenge. In particular, when the light emitting element or the light receiving element is mounted on the substrate, the light emitting element or the light receiving element needs to be mounted after highly accurate alignment is performed, disadvantageously complicating a manufacturing process.

In an optical interconnection in which a plurality of substrates is arranged in a laminated manner, in particular, when an optical signal sent from a first substrate is received by a second substrate serving as a relay and the second substrate then sends the optical signal to a third substrate, the light receiving element needs to be arranged on one surface side of the second substrate, and the light emitting element needs to be arranged on the other surface side of the second substrate. Thus, the light emitting element or the light receiving element needs to be formed on both sides of the substrate, disadvantageously complicating the manufacturing process.

Furthermore, when light emitting elements or light receiving elements are densely arranged in the substrate, even if optical signals are sent and received between the pair of the light emitting element and the light receiving element accurately aligned with each other between different substrates, directivity between the light emitting element and the light receiving element may be weak. Thus, disadvantageously, erroneous transmission of signals (crosstalk) may occur in which an optical signal issued by a light emitting element is received by a light receiving element that should otherwise not receive the optical signal.

One or more embodiments of the invention may enable an increase in alignment accuracy between a light emitting element or a light receiving element on a substrate using a relatively simple manufacturing process, may enable, also when optical signals are sent and received using one substrate as a relay, such a substrate to be formed using a relatively simple manufacturing process, and to allow suppression of signal transmission crosstalk between substrates even when light emitting elements or light receiving elements are densely arranged.

An optical interconnection device according to one or more embodiments of the invention may be configured as follows.

An optical interconnection device in which optical signals are sent and received between a plurality of semiconductor substrates arranged in a laminated manner, wherein a light emitting element or a light receiving element arranged in one of the semiconductor substrates includes a pn junction part that uses the semiconductor substrate as a common semiconductor layer, and is formed on one surface side of the semiconductor substrate, and for a pair of the light emitting element and the light receiving element respectively sending and receiving optical signals between different the semiconductor substrates, light emitted by the light emitting element is transmitted through the semiconductor substrate and received by the light receiving element.

### ADVANTAGEOUS EFFECTS OF ONE OR MORE EMBODIMENTS OF THE INVENTION

In the optical interconnection device with such a characteristic, the plurality of light emitting elements or light receiving elements includes the pn junction part that uses the semiconductor substrate as a common semiconductor layer, and is formed into the one semiconductor substrate using a semiconductor lithography technique. Thus, the alignment accuracy for the light emitting elements or the light receiving elements in the semiconductor substrate can be increased using a relatively simple manufacturing process.

For the pair of the light emitting element and the light receiving element respectively sending and receiving optical signals between different semiconductor substrates, light emitted by the light emitting element is transmitted through the semiconductor substrate and received by the light receiving element. Thus, the light emitting element or the light receiving element may be arranged only on one surface side of the semiconductor substrate to allow a relay substrate to be formed. This also allows the relay substrate with the light emitting element or the light receiving element to be formed using a relatively simple manufacturing process.

The pair of the light emitting element and the light receiving element respectively sending and receiving optical signals between different semiconductor substrates perform light emission and light reception, respectively, at a common wavelength. Thus, even when light emitting elements or light receiving elements are densely arranged, signal transmission crosstalk between substrates (between chips) can be suppressed.

For the pair of the light emitting element and the light receiving element respectively sending and receiving optical signals between different semiconductor substrates, light emitted by the light emitting element is received by the light receiving element via a condenser. Thus, even when light emitting elements or light receiving elements are densely arranged, signal transmission crosstalk between substrates (between chips) can be suppressed.

### BRIEF DESCRIPTION OF DRAWINGS

FIG. 1 is a diagram illustrating an optical interconnection device in accordance with embodiments of the invention.

FIG. 2 is a diagram illustrating the optical interconnection device in accordance with embodiments of the invention.

FIG. 3 is a diagram illustrating a configuration example of a light emitting element or a light receiving element in the optical interconnection device in accordance with embodiments of the invention.

FIG. 4 is a diagram illustrating a method for forming a light emitting element or a light receiving element in the optical interconnection device in accordance with embodiments of the invention.

FIG. 5(a) is a diagram illustrating a cross-sectional configuration of a specific example of the light emitting element or the light receiving element in the optical interconnection device in accordance with embodiments of the invention.

FIG. 5(b) is a diagram illustrating a planar configuration of a specific example of the light emitting element or the light receiving element in the optical interconnection device in accordance with embodiments of the invention.

FIG. 6(a) is a diagram illustrating a step of a specific method for forming a light emitting element or a light receiving element in the optical interconnection device in accordance with embodiments of the invention.

FIG. 6(b) is a diagram illustrating a step of a specific method for forming a light emitting element or a light receiving element in the optical interconnection device in accordance with embodiments of the invention.

FIG. 6(c) is a diagram illustrating a step of a specific method for forming a light emitting element or a light receiving element in the optical interconnection device in accordance with embodiments of the invention.

FIG. 6(d) is a diagram illustrating a step of a specific method for forming a light emitting element or a light receiving element in the optical interconnection device in accordance with embodiments of the invention.

FIG. 7 is a diagram illustrating a form example of the optical interconnection device in accordance with embodiments of the invention.

FIG. 8 is a diagram illustrating a form example of the optical interconnection device in accordance with embodiments of the invention.

FIG. 9 is a diagram illustrating a form example of the optical interconnection device in accordance with embodiments of the invention.

FIG. 10 is a diagram illustrating a form example of the optical interconnection device in accordance with embodiments of the invention.

### DESCRIPTION OF EMBODIMENTS

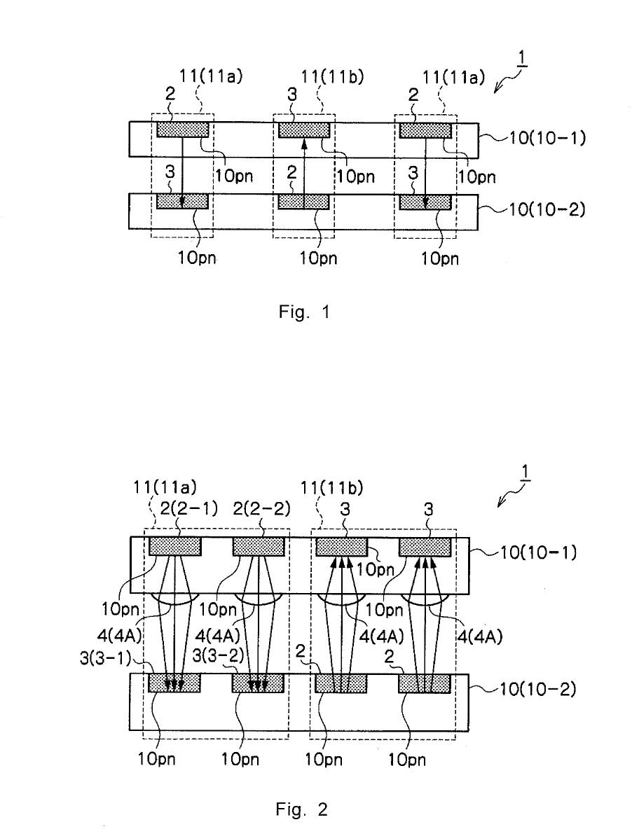

Embodiments of the invention will be described below with reference to the drawings. FIG. 1 and FIG. 2 are diagrams illustrating an optical interconnection device in accordance with embodiments of the invention. An optical interconnection device 1 includes a plurality of semiconductor substrates 10 (10-1, 10-2) arranged in a laminated manner, and optical signals are sent and received between the plurality of semiconductor substrates 10 (10-1, 10-2). In the illustrated example, the two semiconductor substrates 10 are arranged in a laminated manner. However, embodiments of the invention are not limited to this example, and two or more semiconductor substrates 10 may be arranged in a laminated manner.

A light emitting element 2 or a light receiving element 3 is arranged in one of the semiconductor substrates 10. A single light emitting element 2 or light receiving element 3 or a plurality of light emitting elements 2 or light receiving elements 3 may be provided. When a plurality of the light emitting elements 2 or the light receiving elements 3 is arranged, an arrangement form is not particularly limited but may be any arrangement such as a dot matrix-like arrangement, a striped arrangement, or a linear arrangement. Moreover, only the light emitting element 2 may be arranged in one of the semiconductor substrates 10, and only the light receiving element 3 may be arranged in the other semiconductor substrate 10. Besides the light emitting element 2 and the light receiving element 3, the following may be formed or mounted on each semiconductor substrate 10: a drive circuit for driving the light emitting element 2 or the light receiving element 3, an arithmetic processing circuit (integrated circuit) that outputs signals to the drive circuit for the light emitting element 2, an arithmetic processing circuit (integrated circuit) to which signals from the drive circuit for the light receiving element 3 are input, and the like.

In the optical interconnection device 1, the light emitting element 2 or light receiving element 3 arranged in one of the semiconductor substrates 10 includes a pn junction part 10pn that uses the semiconductor substrate 10 as a common semiconductor layer. In addition, the light emitting element 2 or light receiving element 3 arranged in the one of the semiconductor substrates 10 is formed on one surface side of the semiconductor substrate 10.

For the pair of the light emitting element 2 and the light receiving element 3 respectively sending and receiving optical signals between different semiconductor substrates 10 (semiconductor substrate 10-1 and semiconductor substrate 10-2), light emitted by the light emitting element 2 is transmitted through the semiconductor substrate 10 and received by the light receiving element 3. The light emitting element 2 and the light receiving element 3 allow two forms of send and receive parts 11 (11a, 11b) to be formed. In the send and receive part 11a, light emitted by the light emitting element 2 is transmitted through the semiconductor substrate 10 with the light emitting element 2 formed therein and received by the light receiving element 3 formed in the other semiconductor substrate 10. Furthermore, in the send and receive part 11b, light emitted by the light emitting element 2 is transmitted through the other semiconductor substrate 10 and received by the light receiving element 3 formed in the other semiconductor substrate 10.

In the optical interconnection device 1 depicted in FIG. 2, the pair of the light emitting element 2 (2-1, 2-2) and the light receiving element 3 (3-1, 3-2) sending and receiving optical signals between the different semiconductor substrates 10 (10-1, 10-2) perform light emission and light reception, respectively, at a common wavelength. Specifically, when the light emitting element 2-1 in the semiconductor substrate 10-1 and the light receiving element 3-1 in the semiconductor substrate 10-2 respectively send and receive optical signals, the light emitting element 2-1 has a function to emit light with a wavelength λ 1, whereas the light receiving element 3-1 has a function to receive only light with the wavelength λ 1. The light with the wavelength λ 1 as used herein includes light having a wavelength band with a central wavelength near λ 1.

Furthermore, the light emitting elements 2-1, 2-2 arranged adjacently to each other in the semiconductor substrate 10-1 perform light emission at different wavelengths, and the light receiving elements 3-1, 3-2 arranged adjacently to each other in the semiconductor substrate 10-2 perform light reception at different wavelengths. That is, when, the light emitting elements 2-1, 2-2 are arranged adjacently to each other in the semiconductor substrate 10-1 and the light receiving elements 3-1, 3-2 corresponding to the light emitting elements 2-1, 2-2 are arranged adjacently to each other in the semiconductor substrate 10-2, the light emitting element 2-1 emits light at the wavelength λ 1, and the light receiving element 3-1 receives only light with the wavelength λ 1, and the light emitting element 2-2 emits light at a wavelength λ 2, and the light receiving element 3-2 receives only light with the wavelength λ 2.

In this regard, the wavelengths λ 1 and λ 2 need to be wavelengths that can be transmitted through the semiconductor substrate 10. For example, when the semiconductor substrate 10 is a Si substrate, light with the wavelengths λ 1, λ 2 is long-wavelength light with a near-infrared wavelength or longer.

In the optical interconnection device 1 depicted in FIG. 2, the pair of the light emitting element 2 and the light receiving element 3 respectively sending and receiving optical signals between the different semiconductor substrates 10 (10-1, 10-2), light emitted by the light emitting element 2 is received by the light receiving element 3 via a condenser 4. In the illustrated example, the condenser 4 includes the lens part 4A, and the light emitting element 2 or the light receiving element 3 is formed on one surface side of the semiconductor substrate 10, whereas a lens part 4A is formed on the other surface side of the semiconductor substrate 10. The lens part 4A is formed by processing a surface of the semiconductor substrate 10 by etching or the like.

FIG. 3 is a diagram illustrating a configuration example of the light emitting element or light receiving element in the optical interconnection device in accordance with embodiments of the invention. In the optical interconnection device 1, the light emitting element 2 or light receiving element 3 arranged in the semiconductor substrate 10 includes the pn junction part 10pn that uses the semiconductor substrate 10 as a common semiconductor layer. Specifically, the semiconductor substrate 10 includes a first semiconductor layer 10n and a second semiconductor layer 10p that are common semiconductor layers, and the pn junction part 10pn is formed near the boundary between the first semiconductor layer 10n and the second semiconductor layer 10p.

In a specific example, the semiconductor substrate 10 is a Si (silicon) substrate (single crystal substrate), the first semiconductor layer 10n is an n-type Si layer resulting from doping of the semiconductor substrate 10 with impurities selected from 15 group elements, for example, As (arsenic), P (phosphor), and Sb (antimony), and the second semiconductor layer 10p is a p-type semiconductor layer resulting from doping of the first semiconductor layer 10n with impurities selected from 13 group elements, for example, B (boron), Al (aluminum), and Ga (gallium).

In the light emitting element 2 or the light receiving element 3, the periphery of the second semiconductor layer 10p isolated for each light emitting element 2 or light receiving element 3 is partitioned with an insulation film 5, and an electrode 6 is connected to the second semiconductor layer 10p. For the light emitting element 2, a drive circuit 7 that applies a forward voltage to the pn junction part 10pn to drive the light emitting element 2 is connected to the electrode 6. For the light receiving element 3, a drive circuit 7 that detects a voltage resulting from incidence of light on the pn junction part 10pn to drive the light receiving element 3 is connected to the electrode 6. The first semiconductor layer 10n is grounded in the illustrated example.

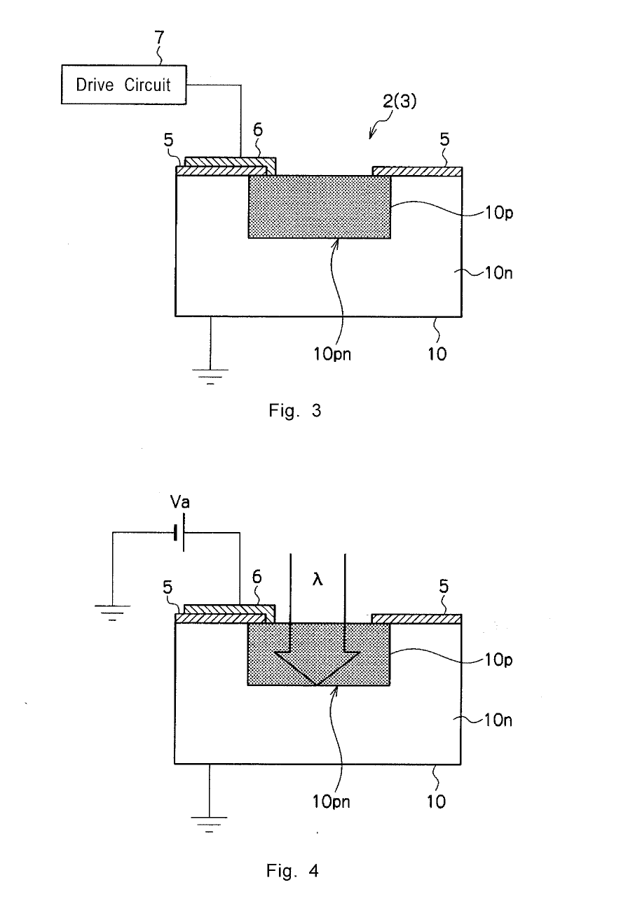

FIG. 4 is a diagram illustrating a method for forming the light emitting element or the light receiving element in the optical interconnection device in accordance with embodiments of the invention. For the light emitting element 2 or the light receiving element 3 formed in the semiconductor substrate 10, a Si (silicon) substrate is used as the semiconductor substrate 10 and doped with impurities selected from 15 group elements, for example, As (arsenic), P (phosphor), and Sb (antimony) to form the first semiconductor layer 10n that serves as a common n-type Si layer. The first semiconductor layer 10n is doped with impurities to pattern and form the second semiconductor layer (p-type semiconductor layer) 10p.

Silicon (Si) is an indirect bandgap semiconductor and has a low light emitting efficiency, and thus, the pn junction part into which the silicon is simply formed fails to achieve useful light emission. However, when the Si substrate is annealed in an optical assist state to generate dressed photons near the pn junction part to apparently change the Si, indirect bandgap semiconductor, into a direct bandgap semiconductor, a high-efficiency and high-output pn junction light emitting function or pn junction light receiving function is obtained.

More specifically, the n-type Si layer (first semiconductor layer 10n) doped with impurities selected from the 15 group elements, for example, As (arsenic), P (phosphor), and Sb (antimony) is doped with impurities selected from the 13 group elements, for example, B (boron), Al (aluminum), and Ga (gallium) at a high concentration to form the second semiconductor layer (p-type semiconductor layer) 10p. Then, the insulation film 5 surrounding the second semiconductor layer (p-type semiconductor layer) 10p is formed. A forward voltage Va is applied to the electrode connected to the second semiconductor layer 10p to pass a current through the pn junction part 10pn to perform an anneal treatment on the second semiconductor layer 10p by Joule heat resulting from the current.

During a process in which the impurities selected from the 13 group elements, for example, B (boron), Al (aluminum), and Ga (gallium) are diffused, light with a particular wavelength λ is radiated to the pn junction part 10pn. Radiation of light during the anneal process allows dressed photons to be generated near the pn junction part 10pn. When dressed photons are thus generated near the pn junction part 10pn, application of the forward voltage to the pn junction part 10pn results in emission of light with a wavelength equivalent to the wavelength λ of light radiated during the anneal process. Furthermore, the pn junction part 10pn functions as a light receiving part with a peak sensitivity to light with the wavelength λ. In this regard, as an example of dope conditions set when B (boron) is selected as impurities of the 13 group element, dose density is set to 5×10¹³/cm², and acceleration energy during implantation is set to 700 keV.

In the formation of each of the pair of the light emitting element 2 and the light receiving element 3 sending and receiving optical signals between the different semiconductor substrates 10 (10-1, 10-2), the wavelength of light radiated during the above-described anneal treatment process is set to the same wavelength λ for both elements. Then, the light emitting wavelength of the light emitting element 2 and the light receiving wavelength of the light receiving element 3 to λ are defined by the wavelength of light radiated during the anneal treatment. The wavelength λ selected in this case is the wavelength of light that can be transmitted through the semiconductor substrate 10. When the semiconductor substrate 10 is a Si substrate, light with a long wavelength equal to or larger than a near-infrared wavelength is selected.

In this case, since the light emitting element 2 and the light receiving element 3 have the same configuration, the element functioning as the light emitting element 2 can be allowed to function as the light receiving element 3, and in contrast, the element functioning as the light receiving element 3 can be allowed to function as the light emitting element 2. This switching can be performed optionally by a peripheral circuit for the optical interconnection device 1 to enable a transmission path for optical signals to be optionally changed.

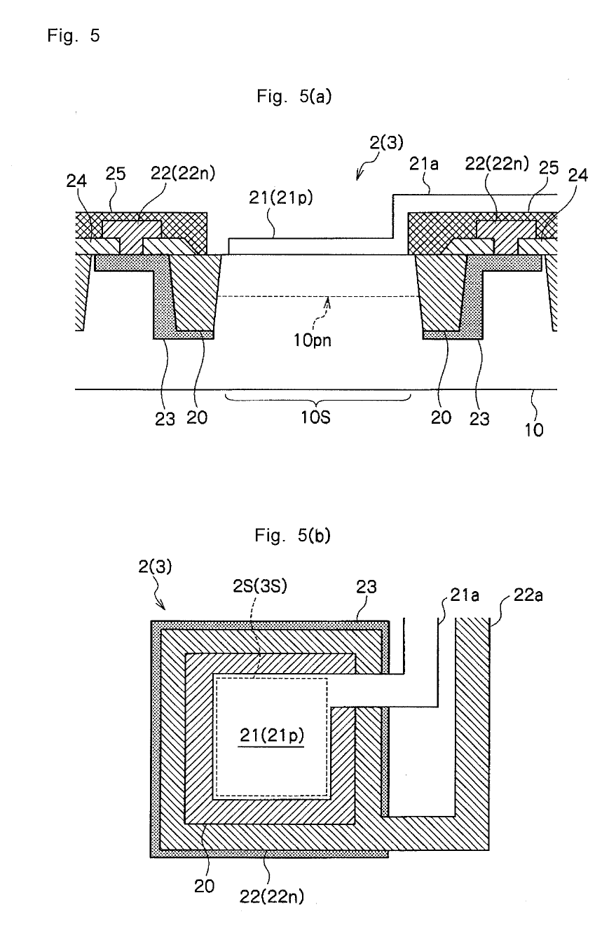

FIG. 5 is a diagram depicting a specific example of the light emitting element or the light receiving element in the optical interconnection device in accordance with embodiments of the invention. FIG. 5(a) depicts a cross-sectional configuration, and FIG. 5(b) denotes a planar configuration. The light emitting element 2 or the light receiving element 3 respectively includes an insulating element isolation layer 20 surrounding the pn junction part 10pn in the semiconductor substrate 10. On one surface side of the semiconductor substrate 10, a first electrode 21 that is one of a p layer electrode and an n layer electrode is arranged inside the element isolation layer 20, and a second electrode 22 that is the other of the p layer electrode and the n layer electrode is arranged outside the element isolation layer 20.

More specifically, the first electrode 21 is a light transmitting p layer electrode 21p, and the second electrode 22 is a metal n layer electrode 22n including an n+ diffusion layer 23 located in an outer peripheral portion of the element isolation layer 20 and connected to the second electrode 22. Leadout wires 21a, 22a are connected to the first electrode 21 and the second electrode 22. A first interlayer insulation film 24 and a second interlayer insulation film 25 are arranged in a laminated manner in order to ensure electric insulation between the first electrode 21 and the second electrode 22, including the leadout wires 21a, 22a (in (b), illustration of the first interlayer insulation film 24 and the second interlayer insulation film 25 is omitted).

In the light emitting element 2 or light receiving element 3 configured as described above, a light emitting part 2S or a light receiving part 3S is formed on the first electrode 21, and in the light emitting part 2S or the light receiving part 3S, a light transmitting part 10S is formed on the other surface side (on the side where the first electrode 21 is not formed) of the semiconductor substrate 10. This enables light emission or light reception via the light transmitting part 10S in the semiconductor substrate 10. In this regard, the flow of a current from the first electrode 21 toward the second electrode 22 forms a channel along the n+ diffusion layer 23 formed in the outer peripheral portion of the element isolation layer 20 surrounding the pn junction part 10pn, thus achieving relatively uniform light emitting or receiving characteristics in the light emitting part 2S or the light receiving part 3S.

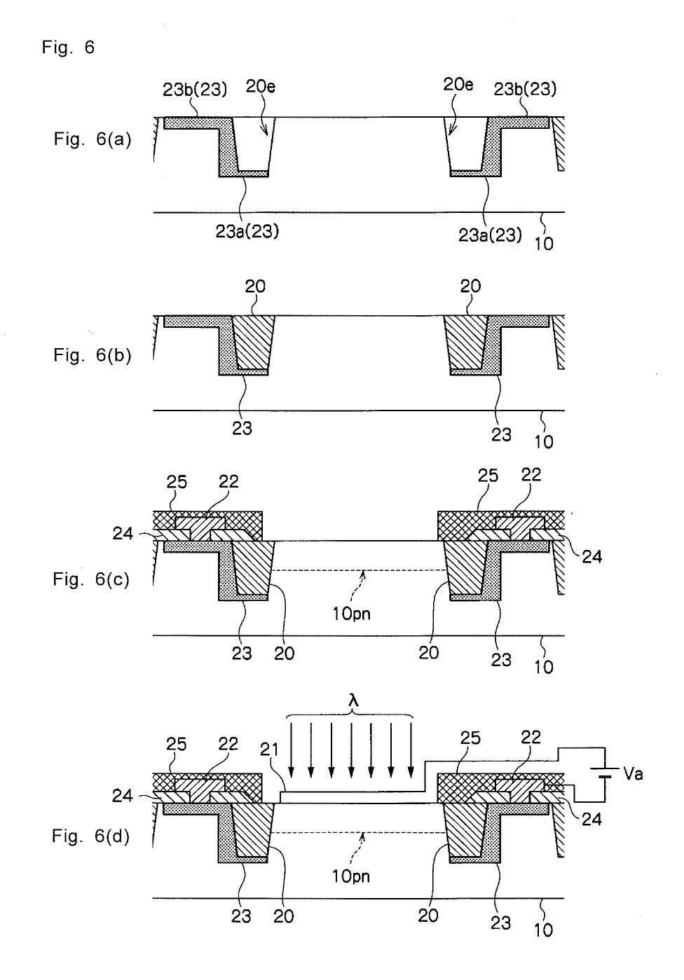

FIG. 6 is a diagram illustrating a specific method for forming a light emitting element or a light receiving element in the optical interconnection device in accordance with embodiments of the invention. First, as depicted in FIG. 6(a), a groove part 20e is formed which is used to process the semiconductor substrate 10 (Si substrate) to form the element isolation layer 20. The groove part 20e can be formed by, for example, anisotropic etching, and is formed to surround the light emitting part or the light receiving part. After the groove part 20e is formed, the n+ diffusion layer 23 is formed by ion implantation of n-type impurities. For the n+ diffusion layer 23, a channel diffusion layer 23a is formed at the bottom and on an outer side of the groove part 20e, and moreover, a contact diffusion layer 23b for connection to the second electrode 22 is formed on a surface of the semiconductor substrate 10.

Then, as depicted in FIG. 6(b), an insulation film such as an oxide film is buried in the groove part 20e to form the element isolation layer 20. Then, as depicted in FIG. 6(c), the first interlayer insulation film 24 is formed, a contact opening to the n+ diffusion layer 23 is formed, and a pattern of the second electrode 22 is formed. Then, the second interlayer insulation film 25 is formed, and an opening is formed in the inside of the element isolation layer 20, which corresponds to the light emitting part or the light receiving part. Impurities selected from the 13 group elements, for example, B (boron), Al (aluminum), Ga (gallium) are implanted into the opening to form the pn junction part 10pn inside the element isolation layer 20.

Then, a transparent conductive film of ITO or the like is deposited on the semiconductor substrate 10 and patterned to form the first electrode 21, and other circuit components are formed. Then, the forward voltage Va is applied between the first electrode 21 and the second electrode 22 to pass a current through the pn junction part 10pn to perform an anneal treatment by Joule heat resulting from the current. In the anneal treatment, during a process in which impurities implanted into the semiconductor substrate 10 and selected from the 13 group elements, for example, B (boron), Al (aluminum), and Ga (gallium) are diffused, light with the particular wavelength λ is radiated to the pn junction part 10pn, so that such radiation of light during the anneal process allows dressed photons to be generated near the pn junction part 10pn.

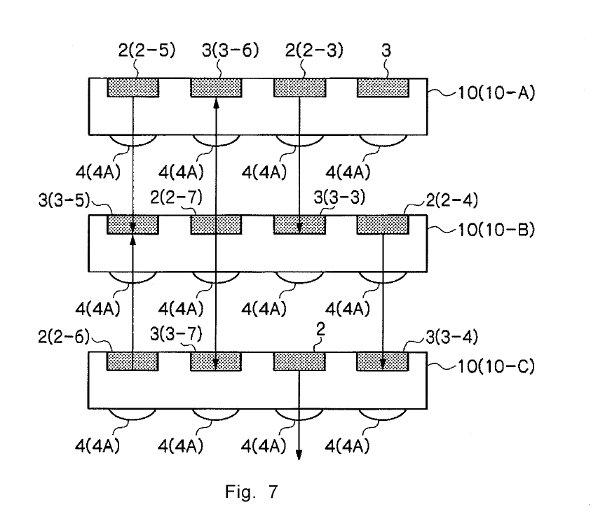

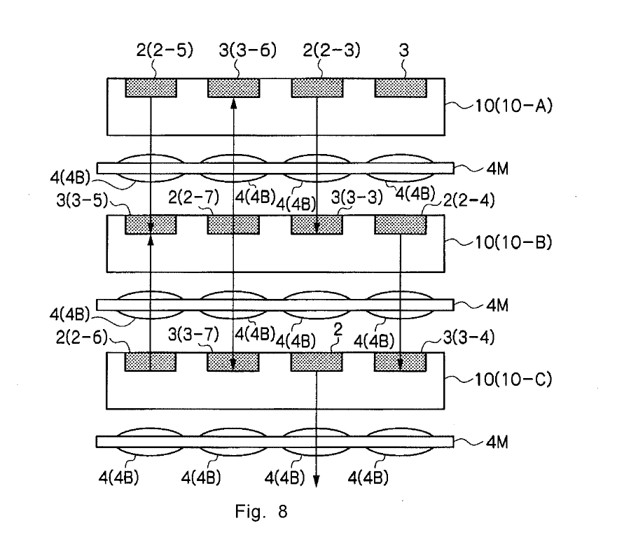

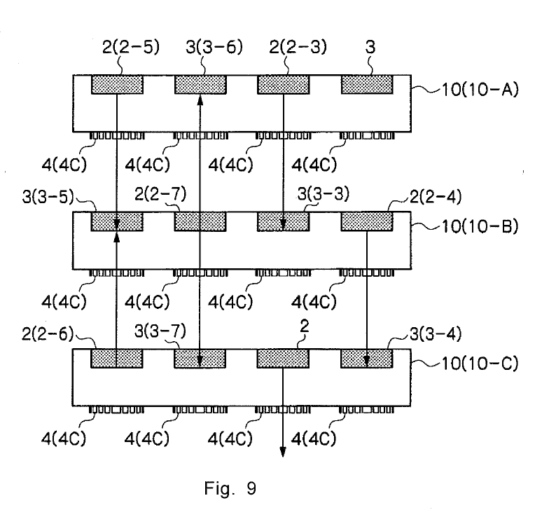

FIGS. 7 to 10 are diagrams illustrating a form example of the optical interconnection device in accordance with embodiments of the invention. FIG. 7, FIG. 8, and FIG. 9 illustrate an example where optical signals can be sent and received among three or more, plurality of semiconductor substrates 10 (10-A, 10-B, 10-C). In the form depicted in FIG. 7, as the condenser 4, the lens part 4A is provided as is the case with the example illustrated in FIG. 2. The light emitting element 2 or the light receiving element 3 is formed on one surface side of the semiconductor substrate 10, whereas the lens part 4A is formed on the other surface side of the semiconductor substrate 10. In a form depicted in FIG. 8, single lenses 4B or lens arrays 4M are installed as the condensers 4, and the single lenses 4B or the lens arrays 4M are arranged between the semiconductor substrates 10 (10-A, 10-B, 10-C). In a form depicted in FIG. 9, diffraction optical elements such as Fresnel zone plates 4C are installed as the condensers 4. As is the case with the example illustrated in FIG. 7, the light emitting element 2 or the light receiving element 3 is formed on one surface side of the semiconductor substrate 10, whereas the diffraction optical elements such as the Fresnel zone plates 4C are formed on the other surface side of the semiconductor substrate 10.

In the examples illustrated in FIGS. 7 to 9, the plurality of light emitting elements 2 and the plurality of light receiving elements 3 are formed on each of the plurality of semiconductor substrates 10 (10-A, 10-B, 10-C). The semiconductor substrate 10-B sandwiched between the semiconductor substrate 10-A and the semiconductor substrate 10-C includes the light receiving element 3 (3-3) that receives an optical signal sent by the light emitting element 2 (2-3) in the semiconductor substrate 10-A, and the light emitting element 2 (2-4) that sends the optical signal to the light receiving element 3 (3-4) in the semiconductor substrate 10-C. In this case, the semiconductor substrate 10-B functions as a relay substrate.

Furthermore, the semiconductor substrate 10-B sandwiched between the semiconductor substrate 10-A and the semiconductor substrate 10-C includes the light receiving element 3 (3-5) that receives optical signals from the light emitting element 2 (2-5) in the semiconductor substrate 10-A and the light emitting element 2 (2-6) in the semiconductor substrate 10-C, and the light emitting element 2 (2-7) that sends the optical signals both to the light receiving element 3 (3-6) in the semiconductor substrate 10-A and to the light receiving element 3 (3-7) in the semiconductor substrate 10-C. In this case, the semiconductor substrate 10-B functions as signal aggregation or a signal transmission source.

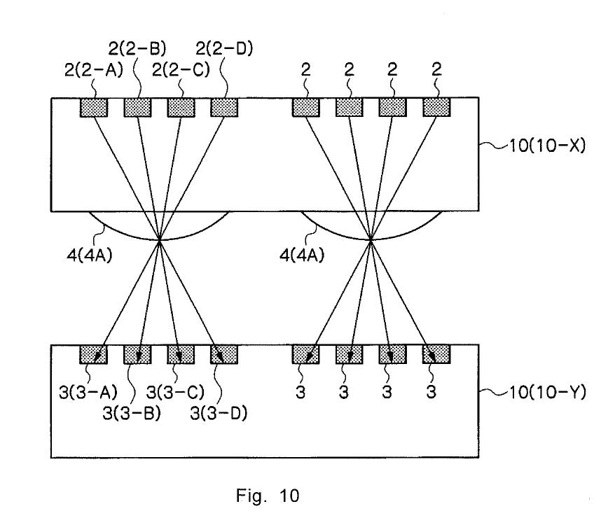

In an example illustrated in FIG. 10, a plurality of the light emitting elements 2 is formed on one of the pair of semiconductor substrates 10 (10-X, 10-Y), whereas a plurality of light receiving elements 3 is formed on the other of the semiconductor substrates 10. The sequential positions of the plurality of light emitting elements 2 in the semiconductor substrate 10-X are in a conjugate relation with the sequential positions of the plurality of light receiving elements 3 in the semiconductor substrate 10-Y with respect to the lens part 4A. The lens part 4A forms images of the plurality of light emitting elements 2 in the semiconductor substrate 10-X, on the plurality of light receiving elements 3 on the semiconductor substrate 10-Y. In this case, the pair of the light emitting element 2 and the light receiving element 3 respectively sending and receiving optical signals, are at conjugate positions. Optical signals emitted by the light emitting elements 2-A, 2-B, 2-C, 2-D are received by the light receiving elements 3-D, 3-C, 3-B, 3-A, respectively, located at diagonal positions.

In the above-described optical interconnection device in accordance with embodiments of the invention, the plurality of light emitting elements 2 or light receiving elements 3 includes the pn junction part 10pn that uses the semiconductor substrate 10 as a common semiconductor layer, and is formed into one semiconductor substrate 10 using a semiconductor lithography technique. Thus, alignment accuracy for the light emitting element 2 or the light receiving element 3 in the semiconductor substrate 10 can be increased using a relatively simple manufacturing process. Furthermore, the pair of the light emitting element 2 and the light receiving element 3 respectively sending and receiving optical signals between the different semiconductor substrates 10 perform light emission and light reception, respectively, at the common wavelength. Thus, signal transmission crosstalk between the semiconductor substrates 10 (between chips) can be suppressed.

Furthermore, the light emitting element 2 or the light receiving element 3 formed in the semiconductor substrate 10 may be formed on one surface side of the semiconductor substrate 10. Thus, this configuration can be easily formed compared to a configuration where the light emitting element or the light receiving element is formed on both surfaces of the semiconductor substrate 10.

Additionally, when light emitted by the light emitting element 2 via the condenser 4 is received by the light receiving element 3, signal transmission crosstalk between the semiconductor substrates 10 (between chips) can be suppressed even if the light emitting elements 2 or the light receiving elements 3 are densely arranged.

In particular, even when optical signals are sent and received between the semiconductor substrate 10 (10-B) and the semiconductor substrates 10 (10-A, 10-C) opposite to the semiconductor substrate 10 (10-B) as illustrated in FIGS. 7 to 9, the optical signals can be sent and received by being transmitted through the semiconductor substrate 10. Thus, the light emitting element 2 or the light receiving element 3 may be arranged only on one surface side of one semiconductor substrate, enabling relatively simple manufacture including the alignment between the elements.

Embodiments of the invention have been described with reference to the drawings. However, the specific configuration is not limited to the described embodiments, and even a change in design or the like which does not depart from the scope of the invention is included in the invention. In addition, the techniques of the embodiments can be combined together.

Further, although the disclosure has been described with respect to only a limited number of embodiments, those skilled in the art, having benefit of this disclosure, will appreciate that various other embodiments may be devised without departing from the scope of the invention. Accordingly, the scope of the invention should be limited only by the attached claims.

### REFERENCE SIGNS LIST

1: optical interconnection device,
2: light emitting element,
2S: light emitting part,
3: light receiving element,
3S: light receiving part,
4: condenser,
5: insulation film,
6: electrode
7: drive circuit
10: semiconductor substrate,
10n: first semiconductor layer (n-type Si layer),
10p: second semiconductor layer (p-type semiconductor layer),
10pn: pn junction part,
20: element isolation layer,
21: first electrode,
22: second electrode,
23: n+ diffusion layer,
24: first interlayer insulation film,
25: second interlayer insulation film

1-11. (canceled)

12. An optical interconnection device in which optical signals are sent and received between a plurality of semiconductor substrates arranged in a laminated manner, wherein
a light emitting element or a light receiving element arranged in one of the semiconductor substrates comprises a pn junction part that uses the semiconductor substrate as a common semiconductor layer, and is formed on one surface side of the semiconductor substrate, and
a pair of the light emitting element and the light receiving element respectively sending and receiving optical signals between different semiconductor substrates (of the plurality of semiconductor substrates) are arranged such that light emitted by the light emitting element is transmitted through the semiconductor substrate and received by the light receiving element.

13. The optical interconnection device according to claim 12, wherein the pair of the light emitting element and the light receiving element respectively sending and receiving optical signals between the different semiconductor substrates perform light emission and light reception, respectively, at a common wavelength.

14. The optical interconnection device according to claim 12, wherein the pair of the light emitting element and the light receiving element respectively sending and receiving optical signals between the different semiconductor substrates are arranged such that light emitted by the light emitting element is received by the light receiving element via a condenser.

15. The optical interconnection device according to claim 14, wherein the condenser is formed on the other surface side of the semiconductor substrate.

16. The optical interconnection device according to claim 14, wherein the condenser is arranged between a pair of the semiconductor substrates.

17. The optical interconnection device according to claim 14, wherein the condenser is a lens.

18. The optical interconnection device according to claim 14, wherein the condenser is a diffraction optical element.

19. The optical interconnection device according to claim 12,
wherein the pn junction part is obtained by performing an anneal treatment on a second semiconductor layer obtained by doping an impurity at a high concentration into a first semiconductor layer that is the common semiconductor layer, while radiating light to the second semiconductor layer, and
wherein a light emitting wavelength of the light emitting element or a light receiving wavelength of the light receiving element is respectively defined by a wavelength of the light radiated during the anneal treatment.

20. The optical interconnection device according to claim 14,
wherein the pn junction part is obtained by performing an anneal treatment on a second semiconductor layer obtained by doping an impurity at a high concentration into a first semiconductor layer that is the common semiconductor layer, while radiating light to the second semiconductor layer, and
wherein a light emitting wavelength of the light emitting element or a light receiving wavelength of the light receiving element is respectively defined by a wavelength of the light radiated during the anneal treatment.

21. The optical interconnection device according to claim 19,
wherein the semiconductor substrate is a Si substrate,
wherein the first semiconductor layer is an n-type semiconductor layer resulting from doping of the semiconductor substrate with a 15 group element, and
wherein the second semiconductor layer is a p-type semiconductor layer resulting from doping with a 13 group element as the impurity.

22. The optical interconnection device according to claim 20,
wherein the semiconductor substrate is a Si substrate,
wherein the first semiconductor layer is an n-type semiconductor layer resulting from doping of the semiconductor substrate with a 15 group element, and
wherein the second semiconductor layer is a p-type semiconductor layer resulting from doping with a 13 group element as the impurity.

23. The optical interconnection device according to claim 12,
wherein the light emitting element or the light receiving element respectively comprises an insulating element isolation layer surrounding the pn junction part in the semiconductor substrate, and
wherein on one surface side of the semiconductor substrate, a first electrode that is one of a p layer electrode and an n layer electrode is arranged inside the element isolation layer, and a second electrode that is the other of the p layer electrode and the n layer electrode is arranged outside the element isolation layer.

24. The optical interconnection device according to claim 14,
wherein the light emitting element or the light receiving element respectively comprises an insulating element isolation layer surrounding the pn junction part in the semiconductor substrate, and
wherein on one surface side of the semiconductor substrate, a first electrode that is one of a p layer electrode and an n layer electrode is arranged inside the element isolation layer, and a second electrode that is the other of the p layer electrode and the n layer electrode is arranged outside the element isolation layer.

25. The optical interconnection device according to claim 19,
wherein the light emitting element or the light receiving element respectively comprises an insulating element isolation layer surrounding the pn junction part in the semiconductor substrate, and
wherein on one surface side of the semiconductor substrate, a first electrode that is one of a p layer electrode and an n layer electrode is arranged inside the element isolation layer, and a second electrode that is the other of the p layer electrode and the n layer electrode is arranged outside the element isolation layer.

26. The optical interconnection device according to claim 23,
wherein the first electrode is a light transmitting p layer electrode,
wherein the second electrode is a metal n layer electrode, and
wherein an n+ diffusion layer connected to the second electrode is provided in an outer peripheral portion of the element isolation layer.

27. The optical interconnection device according to claim 24,
wherein the first electrode is a light transmitting p layer electrode,
wherein the second electrode is a metal n layer electrode, and
wherein an n+ diffusion layer connected to the second electrode is provided in an outer peripheral portion of the element isolation layer.

28. The optical interconnection device according to claim 13, wherein the pair of the light emitting element and the light receiving element respectively sending and receiving optical signals between the different semiconductor substrates are arranged such that light emitted by the light emitting element is received by the light receiving element via a condenser.

29. The optical interconnection device according to claim 13,
wherein the pn junction part is obtained by performing an anneal treatment on a second semiconductor layer obtained by doping an impurity at a high concentration into a first semiconductor layer that is the common semiconductor layer, while radiating light to the second semiconductor layer, and
wherein a light emitting wavelength of the light emitting element or a light receiving wavelength of the light receiving element is respectively defined by a wavelength of the light radiated during the anneal treatment.

30. The optical interconnection device according to claim 15,
wherein the pn junction part is obtained by performing an anneal treatment on a second semiconductor layer obtained by doping an impurity at a high concentration into a first semiconductor layer that is the common semiconductor layer, while radiating light to the second semiconductor layer, and
wherein a light emitting wavelength of the light emitting element or a light receiving wavelength of the light receiving element is respectively defined by a wavelength of the light radiated during the anneal treatment.

31. The optical interconnection device according to claim 18,
wherein the pn junction part is obtained by performing an anneal treatment on a second semiconductor layer obtained by doping an impurity at a high concentration into a first semiconductor layer that is the common semiconductor layer, while radiating light to the second semiconductor layer, and
wherein a light emitting wavelength of the light emitting element or a light receiving wavelength of the light receiving element is respectively defined by a wavelength of the light radiated during the anneal treatment.
